(19) United States
(12) Patent Application Publication
(10) Pub. No.: US 2007/0284955 A1
(43) Pub. Date: Dec. 13, 2007

(54) Heat dissipating fan

(75) Inventors: Shun-Chen Chang, Taoyuan Hsien (TW); Chia-Ming Hsu, Taoyuan Hsien (TW); Tsung-Yu Lei, Taoyuan Hsien (TW); Chin-Sheng Liu, Taoyuan Hsien (TW); Peng-Chu Tao, Taoyuan Hsien (TW); Chia-Ching Lin, Taoyuan Hsien (TW); Shih-Wei Huang, Taoyuan Hsien (TW); Ching-Chuang Mai, Taoyuan Hsien (TW); Wen-Shi Huang, Taoyuan Hsien (TW); Hsiou-Chen Chang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/710,538

(22) Filed: Feb. 26, 2007

(30) Foreign Application Priority Data
Jun. 8, 2006 (TW) 95120364

(51) Int. Cl. H02K 9/06

(52) U.S. Cl. 310/59

(57) ABSTRACT

A heat dissipating fan includes a frame, a first rotor having a shaft and a hub, a base disposed in the frame, a second rotor disposed at one side of the first rotor and coupled to the first rotor, and a driving element supported by the base for driving the first and second rotors to rotate. The hubs of the first and second rotors include a plurality of heat dissipating holes formed on the surface thereof. Airflow passes through the plurality of heat dissipating holes to generate a forced convection effect on the driving element.

### BACKGROUND OF THE INVENTION

1. Field of the Invention

The invention relates to fans, and more particularly to heat dissipating fans providing airflow for dissipating heat from a motor via forced convection.

2. Description of the Related Art

The amount of power required by electric components, and heat generated thereby continually increases with development. Natural convection, a conventional method for dissipating heat, is ineffective for devices that generate excessive heat. Thus, heat dissipating fans, such as those frequently employed in computers, are utilized to ensure thermal efficiency.

In a fan, the motor rotates the rotor to provide airflow for cooling components generating heat. Raising or lowering the rotational speed of a fan regulates the amount of provided airflow. Raising the rotational speed, however, is risky, because at high rotational speeds, vanes of a fan sustain very high pressure, resulting in deformation and broken fan vanes. Additionally, at high rotational speed, the motor bears a greater load, thus, product life is reduced. Waste heat is dissipated via an iron hub 11 exposed to the atmosphere as shown in FIG. 1, wherein the area of the iron hub 11 determines the efficiency of waste heat removal. Motors are becoming increasingly compact and operate at higher speeds. Thus, the efficiency of waste heat dissipation is hindered.

### BRIEF SUMMARY OF THE INVENTION

The invention provides a heat dissipating fan including a plurality of heat dissipating holes formed on a rotor thereof to increase the amount of airflow passing though a motor, thus producing a forced convection effect on the motor for dissipating heat.

An embodiment of the heat dissipating of the invention includes: a frame; a first rotor comprising a shaft and a hub; a base disposed in the frame; a second rotor disposed on one side of the first rotor and coupled to the first rotor; a driving element supported by the base for driving the first and the second rotors to rotate. The hubs of the first and the second rotors comprise a plurality of heat dissipating holes, and airflow passes through the heat dissipating holes to produce a forced convection effect on the driving element as the heat dissipating fan rotates.

The base is coupled to the frame by a plurality of ribs or stationary vanes. The tails of the stationary vanes extend vertically to increase the work capabilities of the second rotor.

Preferably, the number of vanes of the first rotor is different from that of the second rotor. The second rotor is disposed at a windward side or leeward side of the first rotor. The shaft has an end passing though a top of a hub of the second rotor to be fixed thereto via riveting, screwing, gluing or similar ways. The shaft is fixed to the second rotor via riveting, screwing, gluing, or similar. The hub of the second rotor is cup-shaped. The first rotor rotates at the same speed as the second rotor.

The hub preferably comprises inclined inner walls in the heat dissipating holes, or a wing-shaped or planar structure defining the heat dissipating holes on a surface of the hub. The hub of the first rotor may be cone-shaped or leaf-hat-shaped or may comprise an inclined surface.

Another embodiment of the heat dissipating fan further includes a first air-guiding shroud disposed on a side of the frame, and a second air-guiding shroud disposed on another side of the frame. The second air-guiding shroud further comprises a plurality of stationary vanes inside. The first air-guiding shroud or the second air-guiding shroud is expanded at edges or shaped like a ball flare of a trombone. The first air-guiding shroud and the second air-guiding shroud connect to the frame via engaging, riveting, screwing or similar.

The first rotor may further comprise a plurality of vanes disposed extending upward at an incline around the hub and extended.

The first rotor may further comprise a plurality of ears with mounting holes for fixing the heat dissipating fan onto an external system casing.

### BRIEF DESCRIPTION OF THE DRAWINGS

The invention can be more fully understood by reading the subsequent detailed description and examples with references made to the accompanying drawings, wherein:

FIG. 1 is a sectional view of a conventional fan.

FIG. 2 is a sectional view of an embodiment of the heat dissipating fan of the invention.

FIG. 3A is an exploded view of another embodiment of the heat dissipating fan of the invention.

FIG. 3B is a side view of the first rotor of the heat dissipating fan of FIG. 3A.

FIG. 3C is a top view of the first rotor of the heat dissipating fan of FIG. 3A.

FIGS. 4A and 4B are schematic diagrams showing various types of the heat dissipating holes of the heat dissipating fan of FIG. 3A.

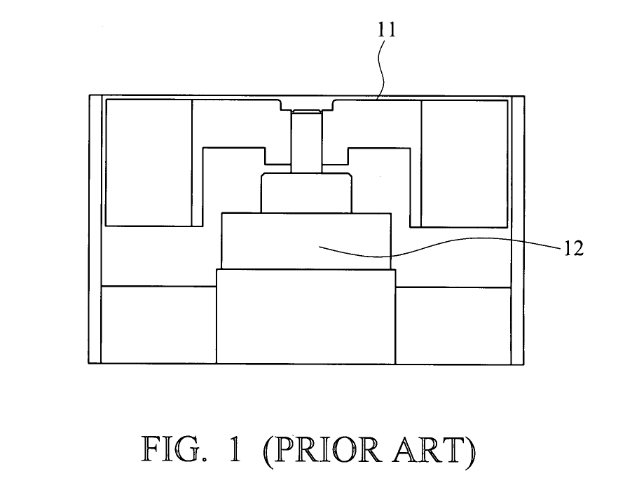

### DETAILED DESCRIPTION OF THE INVENTION

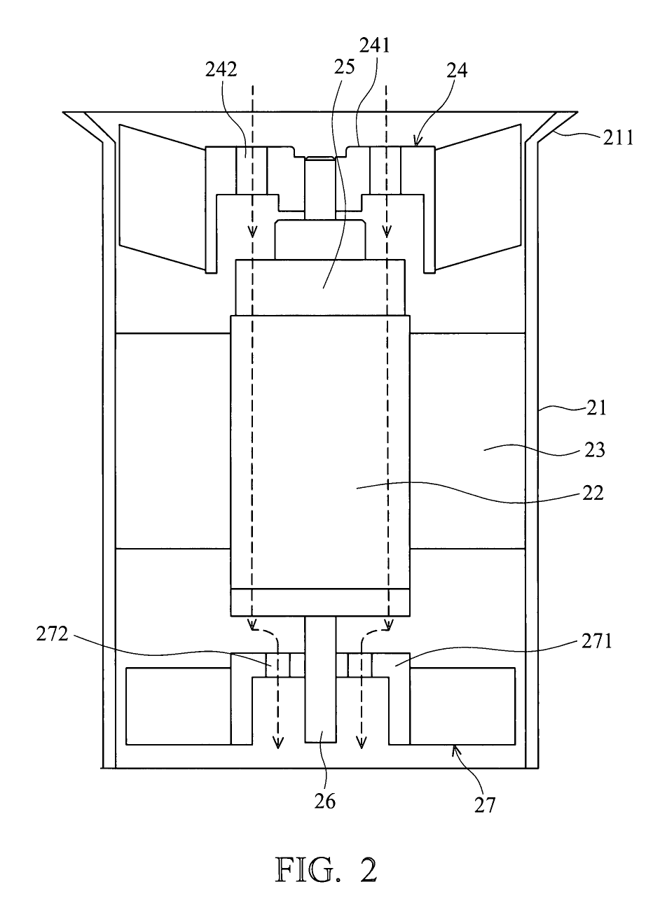

FIG. 2 shows an embodiment of the heat dissipating fan of the invention. The heat dissipating fan includes, a frame 21, a base 22 disposed in the frame, a plurality of ribs 23 disposed between the base 22 and the frame 21, a first rotor 24, a driving element (e.g. motor) 25 disposed in the base and supported by the base 22, a shaft 26, and a second rotor 27 disposed at the rear (i.e. leeward side) of the first rotor 24. The shaft 26 is an end passing through a top of a hub 271 of the second rotor 27 to be fixed thereto. The hub 271 of the second rotor 27 is hollow and shaped like a cup. The ribs 23 in the frame 21 can be replaced by stationary vanes to increase the work capacity of the second rotor 27, thereby increasing airflow pressure. Preferably, tails of the stationary vanes 23 extend vertically to increase the work capacity of the second rotor 27. The shaft 26 is fixed to the second rotor 27 via riveting, screwing, gluing or similar ways. Thus, the driving element 25 drives the first rotor 24 and the second rotor 27 simultaneously via the shaft 26 at the same speed. The number of vanes of the first rotor 24 is different from that of the second rotor 27. For example, the first rotor 24 has eight vanes and the second rotor 27 has nine vanes to reduce noise.

The first rotor 24 and the second rotor 27 respectively have a plurality of heat dissipation holes 242 and 272 at the tops of their hubs. When the first rotor 24 and the second rotor 27 rotate via the driving element 25, airflow passes through the heat dissipating holes 242 and 272 of the hubs of the first rotor 24 and the second rotor 27 for dissipating heat produced by the driving element 25 so as to prolong the life of the driving element 25. The vanes of the first rotor 24 are extended upward at an inclined angle, and the frame 21 has an expanding portion 211 at an end thereof for collecting more airflow.

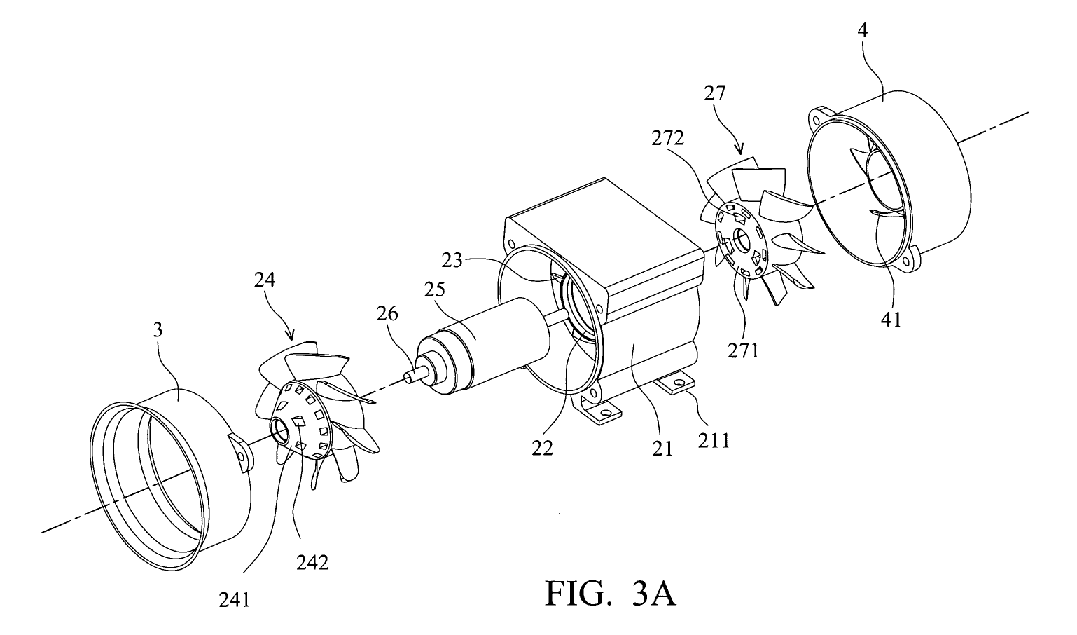

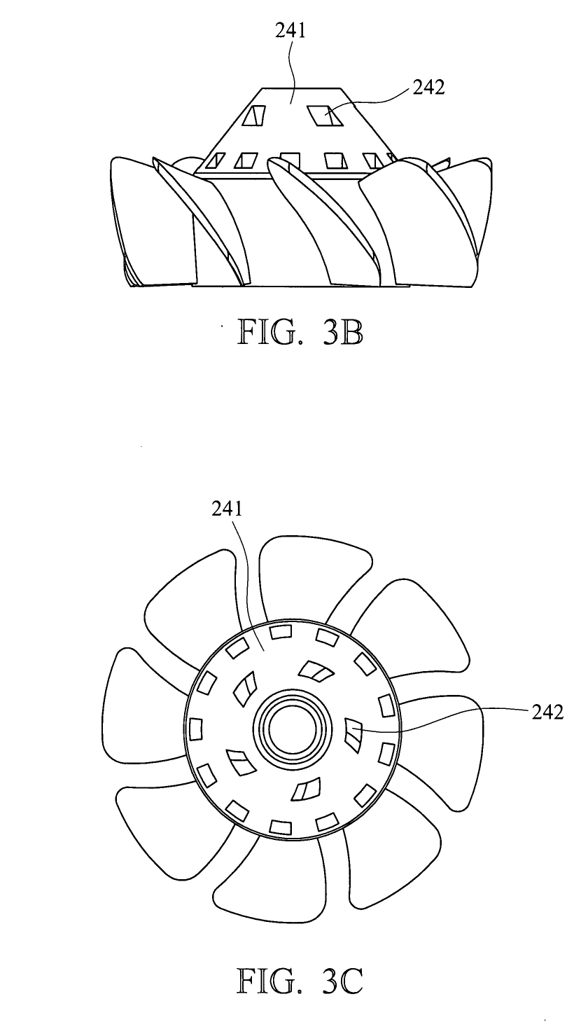

FIGS. 3A to 3C show another embodiment of the heat dissipating fan of the invention. The structures illustrated in FIGS. 3A to 3C are similar to the previously described embodiment expect that a top surface of the hub of the first rotor 24 is cone-shaped, leaf-hat-shaped or inclined and the hubs have inclined inner walls in the heat dissipating holes 242 and 272. The heat dissipating fan further includes a first air-guiding shroud 3 and a second air-guiding shroud 4 disposed respectively on opposite sides of the frame 21. Additionally, the second air-guiding shroud 4 includes a plurality of internal stationary vanes 41 for increasing the pressure of airflow passing through the vanes. Thus, the heat dissipation is effectively increased. The first air-guiding shroud 3 can also have a plurality of internal stationary vanes. The first air-guiding shroud 3 and the second air-guiding shroud 4 are preferably expanded at the edges or bell-shaped. The first air-guiding shroud 3 and the second air-guiding shroud 4 are connected to the frame 21 via engaging, riveting, screw, gluing or similar ways. The frame 21 includes a plurality of ears for fixing the heat dissipation fan to the casing of an external system.

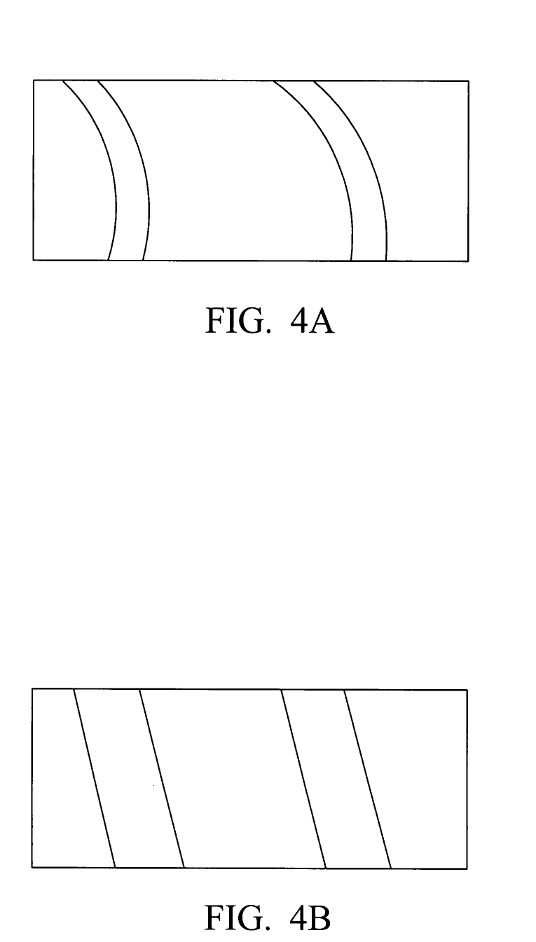

The heat dissipating holes on the hub of the first rotor or the second rotor are wing-shaped or flat plat-shaped. From FIGS. 4A to 4B, when the motor rotates the rotor, the vans of the first and second rotors generate airflow and forced convection is produced via the wing-shaped or flat plate-shaped holes in the hub area. The airflow dissipates heat generated by the motor.

As described above, the invention provides a small and powerful heat dissipating fan in which several rotors are driven via a single high-efficiency driving element (or motor). In addition, a plurality of heat dissipating holes are provided in the rotor such that airflow enters via the heat dissipating holes of the front rotor and exits via the heat dissipating holes in the back of the rotor to overcome high resistance in the motor. When the motor consumes power of more than 100 W, the rotor of the invention reduces the operating temperature by about 20 degrees. Thus, the invention efficiently dissipates waste heat produced from the wire windings of a high-efficiency motor, increases airflow passing through the motor, increases heat convection efficiency, and reduces temperature of the motor, thereby protecting the motor and extending product life.

While the invention has been described by way of example and in terms of preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A heat dissipating fan comprising
a frame;
a first rotor comprising a shaft;
a base disposed in the frame;
a second rotor disposed at one side of the first rotor and coupled to the first rotor; and
a driving element supported by the base for driving the first and second rotors to rotate;
wherein hubs of the first and the second rotors comprise a plurality of heat dissipating holes for allowing passage of airflow through the first and second rotors.

2. The heat dissipating fan as claimed in claim 1, wherein the base is coupled to the frame by a plurality of ribs or stationary vanes.

3. The heat dissipating fan as claimed in claim 1, further comprising a plurality of stationary vanes disposed between the first and second rotors in the frame.

4. The heat dissipating fan as claimed in claim 3, wherein tails of the stationary vanes are vertically extended.

5. The heat dissipating fan as claimed in claim 1, wherein vanes of the first rotor are different from those of the second rotor in number.

6. The heat dissipating fan as claimed in claim 1, wherein the second rotor is disposed on a windward side or leeward side of the first rotor.

7. The heat dissipating fan as claimed in claim 1, wherein the shaft has an end passing through a top of a hub of the second rotor to be fixed thereto via riveting, screwing, gluing or similar ways.

8. The heat dissipating fan as claimed in claim 1, wherein the hub of the second rotor is cup-shaped.

9. The heat dissipating fan as claimed in claim 1, wherein the first rotor rotates at the same speed as the second rotor.

10. The heat dissipating fan as claimed in claim 1, wherein the hubs comprise inclined inner walls in the heat dissipating holes.

11. The heat dissipating fan as claimed in claim 1, wherein the heat dissipating holes are defined by wing-shaped or plat-shaped structure formed on one surface of the hubs.

12. The heat dissipating fan as claimed in claim 1, wherein the hub of the first rotor is cone-shaped or leaf-hat-shaped or comprises an inclined surface.

13. The heat dissipating fan as claimed in claim 1, further comprising a first air-guiding shroud disposed on a side of the frame.

14. The heat dissipating fan as claimed in claim 13, further comprising a second air-guiding shroud disposed on another side of the frame.

15. The heat dissipating fan as claimed in claim 14, wherein the second air-guiding shroud comprises a plurality of stationary vanes inside.

16. The heat dissipating fan as claimed in claim 14, wherein the first or second air-guiding shroud is expanded at edges or ball-shaped.

17. The heat dissipating fan as claimed in claim 14, wherein the first air-guiding shroud and the second air-guiding shroud are connected to the frame via engaging, riveting, screwing or gluing.

18. The heat dissipating fan as claimed in claim 1, wherein the first rotor further comprises a plurality of vanes disposed around the hub.

19. The heat dissipating fan as claimed in claim 18, wherein vanes of the first rotor extend upward at an inclined angle.

20. The heat dissipating fan as claimed in claim 1, wherein the frame comprises a plurality of ears with mounting holes for fixing the heat dissipating fan onto at external system casing.
